(19) United States
(12) Patent Application Publication
(10) Pub. No.: US 2022/0143836 A1
(43) Pub. Date: May 12, 2022

(54) COMPUTER-READABLE RECORDING MEDIUM STORING OPERATION CONTROL PROGRAM, OPERATION CONTROL METHOD, AND OPERATION CONTROL APPARATUS

(71) Applicant: FUJITSU LIMITED, Kawasaki-shi (JP)

(72) Inventors: Yasuto Yokota, Kawasaki (JP); Kanata Suzuki, Kawasaki (JP)

(73) Assignee: FUJITSU LIMITED, Kawasaki-shi (JP)

(21) Appl. No.: 17/464,732

(22) Filed: Sep. 2, 2021

(30) Foreign Application Priority Data
Nov. 11, 2020 (JP) 2020-187982

(51) Int. Cl. B25J 9/16; G06T 7/70; G06T 7/11

(52) U.S. Cl. CPC B25J 9/1697; B25J 9/1664; G06T 7/11; G06T 7/70

(57) ABSTRACT

A non-transitory computer-readable recording medium stores an operation control program for causing a computer to execute processing including: detecting a position of an object included in an operating environment of a device; specifying an operation path of the device on the basis of an operation position of the device and the position of the object; generating first operation information on the basis of the operation path and reference information that associates position information of a plurality of points included in the operating environment with operation information that represents an operating state of the device when the plurality of points are the operation positions; and controlling the device on the basis of the first operation information.

### CROSS-REFERENCE TO RELATED APPLICATION

This application is based upon and claims the benefit of priority of the prior Japanese Patent Application No. 2020-187982, filed on Nov. 11, 2020, the entire contents of which are incorporated herein by reference.

### FIELD

The embodiment discussed herein is related to an operation control technology.

### BACKGROUND

In recent years, to reduce teaching work of teaching operations to industrial robot arms, research is advancing on automating the teaching work by applying a machine learning technology such as deep reinforcement learning and recurrent neural networks to attitude control of robot arms. In the deep reinforcement learning, training needs a large cost (many trials) and a long time. Thus, in a case where there are restrictions on a cost and a training time, methods using the recurrent neural networks such as a recurrent neural network (RNN) and a long short-term memory (LSTM) are used.

Japanese Laid-open Patent Publication No. 2018-089728, Japanese Laid-open Patent Publication No. 2020-062701, and U.S. Patent Application Publication No. 2019/0091864 are disclosed as related art.

### SUMMARY

According to an aspect of the embodiments, a non-transitory computer-readable recording medium stores an operation control program for causing a computer to execute processing including: detecting a position of an object included in an operating environment of a device; specifying an operation path of the device on the basis of an operation position of the device and the position of the object; generating first operation information on the basis of the operation path and reference information that associates position information of a plurality of points included in the operating environment with operation information that represents an operating state of the device when the plurality of points are the operation positions; and controlling the device on the basis of the first operation information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of an operation control system;

FIG. 2 is a diagram illustrating an example of a six-axis robot arm;

FIG. 3 is a diagram illustrating an exemplary configuration of an operation control apparatus;

FIG. 4 is a diagram illustrating an example of specification of a region of an object;

FIG. 5 is a diagram illustrating an example of an operation range of the robot arm and imaginary points;

FIG. 6 is a diagram illustrating an example of specification of an operation path for avoiding an obstacle;

FIG. 7 is a diagram illustrating an example of generation of attitude information on the operation path;

FIG. 8 is a flowchart illustrating a flow of operation control processing; and

FIG. 9 is a diagram for explaining an exemplary hardware configuration.

### DESCRIPTION OF EMBODIMENTS

On the other hand, development of a robot arm assuming collaboration with humans is advancing, and a technology that prevents collision between the robot arm and another object is needed. Thus, there is a technology that detects an obstacle by using a camera image or a sensor, specifies three-dimensional position coordinates (x, y, z), and prevents collision between a robot arm and the obstacle.

However, since a track of the robot arm is determined by attitude information of an operation set in advance or machine-learned operation, it is not possible to perform an irregular operation that is not set in advance or machine-learned, such as avoiding an unexpected obstacle. Thus, when the obstacle is detected, an operation of the robot arm needs to be uniformly stopped in an emergency, which causes a problem that a work load and time for unnecessary restarting are needed.

In one aspect, an operation control program, an operation control method, and an operation control apparatus that are capable of generating a track of a robot arm for avoiding an obstacle may be provided.

Hereinafter, embodiments of an operation control program, an operation control method, and an operation control apparatus according to the present embodiment will be described in detail with reference to the drawings. Note that the embodiments do not limited the present embodiment. Furthermore, each of the embodiments may be appropriately combined within a range without inconsistency.

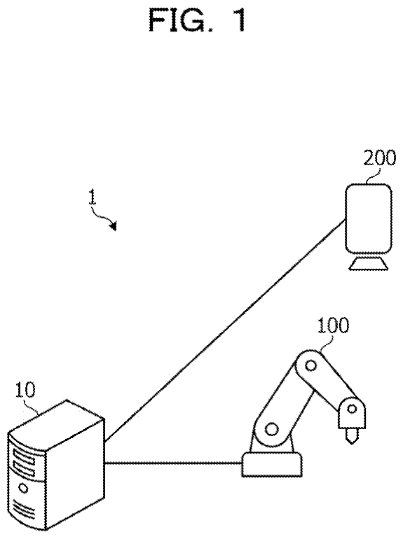

First, an operation control system for implementing the present embodiment will be described. FIG. 1 is a diagram illustrating an exemplary configuration of the operation control system. As illustrated in FIG. 1, an operation control system 1 is a system in which an operation control apparatus 10, a robot arm 100, and a camera device 200 are communicatively connected to each other. Note that communication of each device may be performed via a communication cable or may be performed via various communication networks such as an intranet. Furthermore, a communication method may be either wired method or wireless method.

The operation control apparatus 10 is, for example, an information processing apparatus such as a desktop personal computer (PC), a notebook PC, or a server computer used by an administrator who manages the robot arm 100. The operation control apparatus 10 detects an object in an operating environment of the robot arm 100, generates an operation path and operation information of the robot arm 100 for avoiding the object, and controls the robot arm 100. Note that the object detected in the operating environment of the robot arm 100 may be referred to as an obstacle regardless of whether or not there is a possibility of actually colliding with the robot arm 100.

Note that, although the operation control apparatus 10 is illustrated as one computer in FIG. 1, the operation control apparatus 10 may be a distributed computing system including a plurality of computers. Furthermore, the operation control apparatus 10 may be a cloud server device managed by a service provider that provides a cloud computing service.

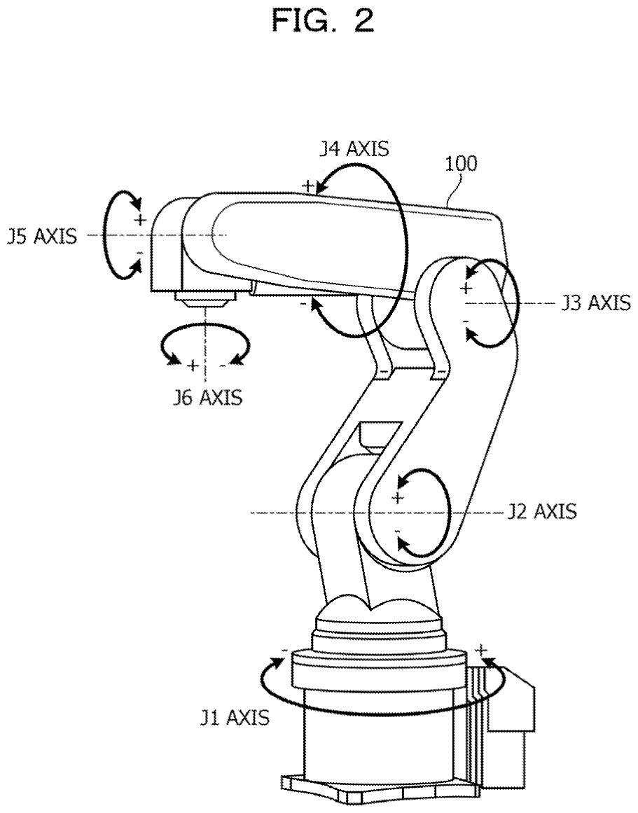

The robot arm 100 is, for example, a robot arm for industrial use, and is, more specifically, a picking robot that picks up (grips) and moves an article in a factory, a warehouse, or the like. FIG. 2 is a diagram illustrating an example of a six-axis robot arm. In the example of FIG. 2, the robot arm 100 has six joints J1 to J6, and rotates around J1 to J6 axes of the joints. The robot arm 100 receives input of change for each time in attitude information, for example, in an angle of the axis of each joint from the operation control apparatus 10, so that a track of the robot arm 100 is determined and the robot arm 100 is controlled to perform a predetermined operation. Note that the number of axes of the robot arm 100 is not limited to six axes, and may be less or more than six axes, such as five axes or seven axes.

The camera device 200 captures, from a side of or above the robot arm 100, an image of an operating environment of the robot arm 100, for example, a range in which the robot arm 100 may operate. The camera device 200 captures the image of the operating environment in real time while the robot arm 100 is operating, and the captured image is transmitted to the operation control apparatus 10. Note that, although only one camera device 200 is illustrated in FIG. 1, images of the operating environment may be captured from a plurality of directions such as the side of and above the robot arm 100 by a plurality of the camera devices 200.

[Functional Configuration of Operation Control Apparatus 10]

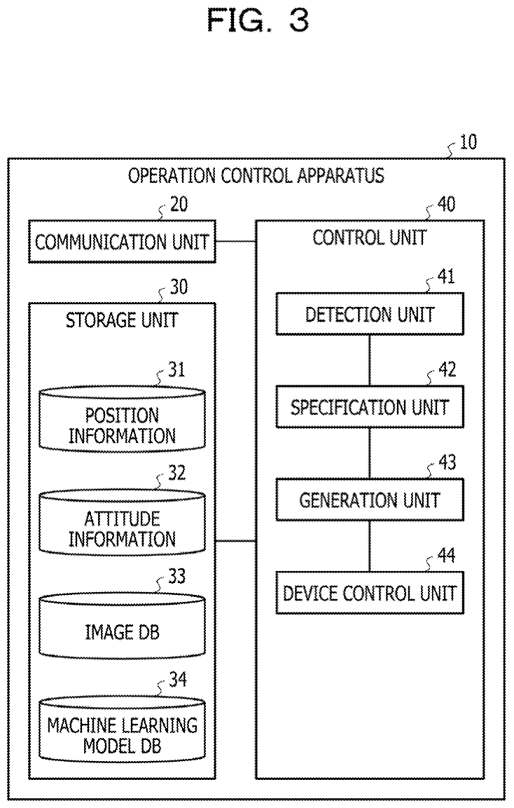

Next, a functional configuration of the operation control apparatus 10 illustrated in FIG. 1 will be described. FIG. 3 is a diagram illustrating an exemplary configuration of the operation control apparatus. As illustrated in FIG. 3, the operation control apparatus 10 includes a communication unit 20, a storage unit 30, and a control unit 40.

The communication unit 20 is a processing unit that controls communication with another device such as the robot arm 100 or the camera device 200, and is, for example, a communication interface such as a universal serial bus (USB) interface or a network interface card.

The storage unit 30 is an example of a storage device that stores various types of data and a program executed by the control unit 40, and is, for example, a memory, a hard disk, or the like. The storage unit 30 stores position information 31, attitude information 32, an image database (DB) 33, a machine learning model DB 34, and the like.

The position information 31 stores three-dimensional position information of a plurality of imaginary points preset in a space within an operation range of the robot arm 100. The imaginary points are, for example, apexes of each triangular pyramid when triangular pyramids of a predetermined size are arranged side by side so as to fill the space within the operation range of the robot arm 100.

The attitude information 32 is information for controlling an operation of the robot arm 100, and stores information indicating an angle of the axis of each joint of the robot arm 100. The attitude information 32 of a normal operation in a case where no obstacle is detected in an operating environment of the robot arm 100 is created in advance, or the attitude information 32 of the next operation is determined by a machine learning model. Furthermore, for example, in the case of the six-axis robot arm illustrated in FIG. 2, the attitude information 32 indicates angles of the J1 to J6 axes of the joints by m1 to m6. Furthermore, the attitude information 32 stores, for example, attitude information when a tip of the robot arm 100 is positioned at each of imaginary points indicated by the position information 31.

The image DB 33 stores a captured image of the operating environment of the robot arm 100 captured by the camera device 200. Furthermore, the image DB 33 stores a mask image indicating a region of an obstacle, which is output by inputting the captured image to an object detector.

The machine learning model DB 34 stores, for example, model parameters for constructing an object detector generated by machine learning using a captured image of the operating environment of the robot arm 100 as a feature amount and a mask image indicating a region of an obstacle as a correct label, and training data for the object detector.

Furthermore, the machine learning model DB 34 stores, for example, model parameters for constructing a recurrent neural network (RNN) generated by machine learning using current attitude information 32 as a feature amount and future attitude information 32 as a correct label, and training data for the RNN.

Note that the information described above stored in the storage unit 30 is merely an example, and the storage unit 30 may store various types of information other than the information described above.

The control unit 40 is a processing unit that controls the entire operation control apparatus 10 and is, for example, a processor. The control unit 40 includes a detection unit 41, a specification unit 42, a generation unit 43, and a device control unit 44. Note that each processing unit is an example of an electronic circuit included in a processor or an example of a process executed by the processor.

The detection unit 41 detects a position of an object included in an operating environment of a device such as the robot arm 100. More specifically, the detection unit 41 may specify a region of the object in an image obtained by capturing the operating environment of the device such as the robot arm 100 by using the camera device 200 from at least one direction such as a side of or above the device, and detect the position of the object. Note that the region of the object may be specified from a mask image output by using, for example, an object detector generated by machine learning using the captured image of the operating environment of the robot arm 100 as a feature amount and a mask image indicating a region of an obstacle as a correct label.

Furthermore, a plurality of the camera devices 200 may capture images of the operating environment from a plurality of directions such as a side of and above the device. In this case, the detection unit 41 specifies the region of the object in each image captured from each direction, and detects the position of the object. Note that, by capturing the images of the operating environment from the plurality of directions such as the side of and above the device by the plurality of camera devices 200, the detection unit 41 may also specify the region of the object in each image captured from each direction, and detect the position of the object three-dimensionally.

Furthermore, the detection unit 41 detects that the object has disappeared from the operating environment of the device such as the robot arm 100. With this configuration, an operation of the device that has been operated so as to avoid the object may be returned to a normal operation.

The specification unit 42 specifies, on the basis of an operation position of a device such as the robot arm 100 and a position of an object, an operation path of the device. More specifically, for example, on the basis of the position information 31 of a plurality of imaginary points preset in a space within an operation range of the robot arm 100 and a position of an object detected by the detection unit 41, the specification unit 42 calculates a distance between each of the plurality of imaginary points and the object. Then, the specification unit 42 uses position information of imaginary points with the calculated distance is equal to or lower than a predetermined threshold to set a predetermined region including the object as a region where path search is not possible, and specifies the operation path of the device on the basis of the operation position of the device so as to avoid the region.

The generation unit 43 generates the attitude information 32 to enable operation along an operation path on the basis of reference information that associates the position information 31 of a plurality of imaginary points with the attitude information 32 that is operation information representing an operating state of the device when the imaginary points are the operation positions, and the operation path specified by the specification unit 42. For example, points are set at regular intervals on the specified operation path, and on the basis of the reference information that associates the position information 31 of the plurality of imaginary points with the attitude information 32 of the device when the imaginary points are the operation positions, the attitude information 32 of the device when the point at the regular intervals are the operation positions is interpolated and calculated.

The device control unit 44 controls a device such as the robot arm 100 on the basis of the attitude information 32 generated by the generation unit 43. With this configuration, the device may operate to avoid an object. Furthermore, in a case where the detection unit 41 detects that the object has disappeared from an operating environment of the device, the device control unit 44 returns the attitude information 32 to the attitude information 32 of the normal operation to control the device. As described above, the attitude information 32 of the normal operation is the attitude information 32 for performing an operation in a case where an obstacle is not detected, which is created and set in advance or determined by a machine learning model.

[Details of Functions]

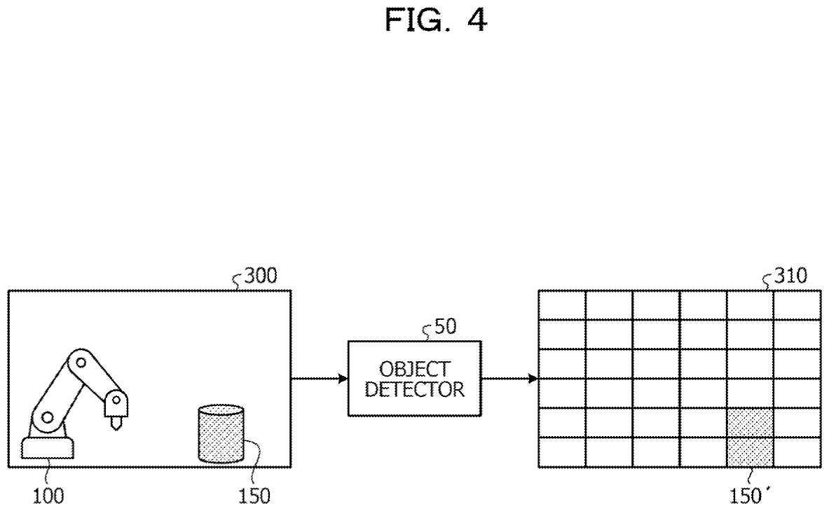

Next, each function will be described in detail with reference to FIGS. 4 to 7. First, specification of a region of an object in an image obtained by capturing an operating environment of a device such as the robot arm 100 by the detection unit 41 will be described. FIG. 4 is a diagram illustrating an example of the specification of the region of the object. A captured image 300 is an image obtained by capturing an operating environment of the robot arm 100 by the camera device 200 from a side of the robot arm 100. In addition to the robot arm 100, the captured image 300 includes an object 150 that may be an obstacle.

An object detector 50 illustrated in FIG. 4 is generated by machine learning using the captured image of the operating environment of the robot arm 100 as a feature amount and a mask image indicating a region of the object as a correct label. The object detector 50 detects an object from an image by using, for example, a single shot multibox detector (SSD) of object detection algorithm.

In FIG. 4, a mask image 310 output by inputting the captured image 300 to the object detector 50 is acquired. The mask image 310 is, for example, binarized representation of pixels 150′ of the object 150 and other pixels, whereby the specification unit 42 may specify the object 150. Furthermore, as illustrated in FIG. 4, by lowering a resolution of the mask image 310 to be lower than a resolution of the captured image 300, a processing load of the operation control apparatus 10 on the mask image 310 may be reduced.

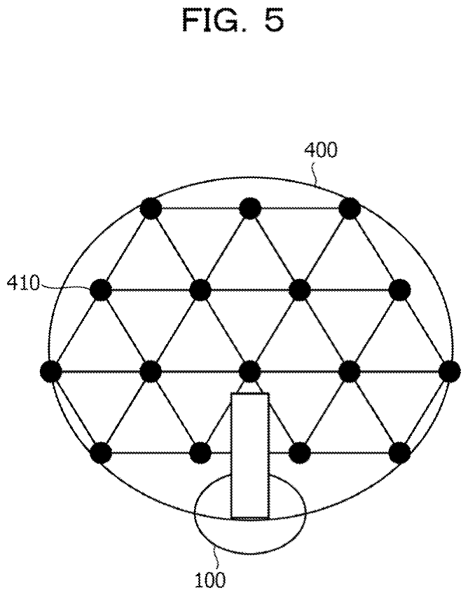

Next, imaginary points preset in a space within an operation range of a device such as the robot arm 100 will be described. FIG. 5 is a diagram illustrating an example of the operation range of the robot arm and the imaginary points. FIG. 5 illustrates an image of an operating environment of the robot arm 100 as viewed from above, and an operation range 400 indicates a range in which the robot arm 100 may operate. For example, when there is any object within the operation range 400, there is a possibility that the robot arm 100 and the object collide with each other.

Thus, for example, in order to detect a position of the object that may be an obstacle, triangular pyramids of a predetermined size are arranged side by side so as to fill a space within the operation range 400, for example, imaginary points 410, which are apexes of each triangular pyramid, are set, and the position information 31 of each point is stored. Note that, in the example of FIG. 5, although the triangular pyramids are illustrated as triangles since the triangular pyramids are viewed from above, description will be made by using the term triangular pyramid. Furthermore, for example, the attitude information 32 of the robot arm 100 when the tip of the robot arm 100 is positioned at each of the imaginary points 410 is acquired and stored in advance by manual operation. The attitude information 32 acquired here is used to specify an operation path for avoiding an obstacle, which will be described later. Furthermore, when the attitude information 32 is acquired, by operating the robot arm 100 so as to draw sides of a triangular pyramid in a spiral shape with a single stroke, it is possible to prevent a difference between pieces of the attitude information 32 of adjacent imaginary points 410 from becoming too large.

Note that a length of one side of a triangular pyramid may be set to, for example, 20 cm (centimeters), but the length of one side is not limited to this length. Furthermore, the triangular pyramids and imaginary points 410 as illustrated in FIG. 5 are merely virtually set in order for the operation control apparatus 10 to recognize the positions in the space, and do not mean that something is physically arranged in the space. Furthermore, a shape of the arrangement is not limited to the triangular pyramid, and may be another figure such as a cube.

Furthermore, in the example of FIG. 5, the operating environment of the robot arm 100 is illustrated as the image viewed from above. However, imaginary points 410 may be set in the operation range 400 viewed from another direction, for example, a side. Moreover, for example, by setting imaginary figures or imaginary points 410 in the operation range 400 viewed from a plurality of directions such as the side and above, the operation control apparatus 10 may three-dimensionally recognize the position of the device such as the robot arm 100 within the operation range 400.

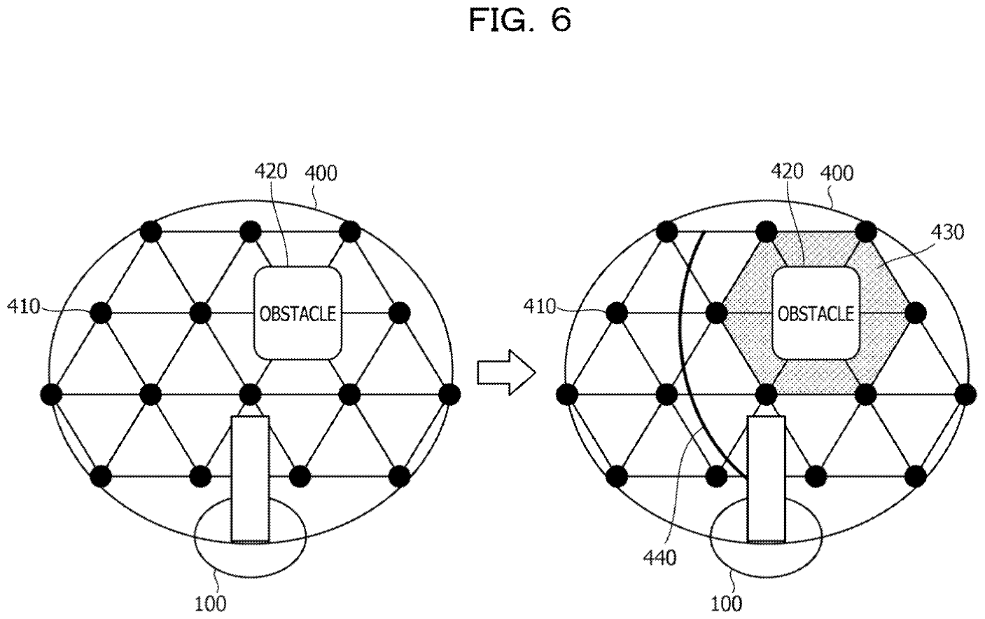

Next, specification of an operation path for avoiding an obstacle by the specification unit 42 will be described. FIG. 6 is a diagram illustrating an example of the specification of the operation path for avoiding the obstacle. On the basis of the position information 31 of the imaginary points 410 preset in a space within the operation range 400 of the robot arm 100 and a position of an obstacle 420 which is an object detected by the detection unit 41, the specification unit 42 calculates a distance between each of the imaginary points 410 and the obstacle 420. Next, the specification unit 42 uses the position information 31 of the imaginary points 410 with the calculated distance of equal to or lower than a predetermined threshold, for example, 10 cm, to determine a predetermined region including the obstacle 420 as a region 430 where path search is not possible. In the example of FIG. 6, the region 430 where path search is not possible is a hexagonal region including the obstacle 420, as illustrated on a right side of FIG. 6. For example, in the example of FIG. 6, apexes of triangular pyramids constituting the hexagon are the imaginary points 410 with the calculated distance of equal to or lower than the predetermined threshold. Then, the specification unit 42 uses a path planning method such as a rapidly-exploring random tree (RRT) or Dijkstra's algorithm to specify an operation path 440 of the robot arm 100 to a target position so as to avoid the region 430 where path search is not possible.

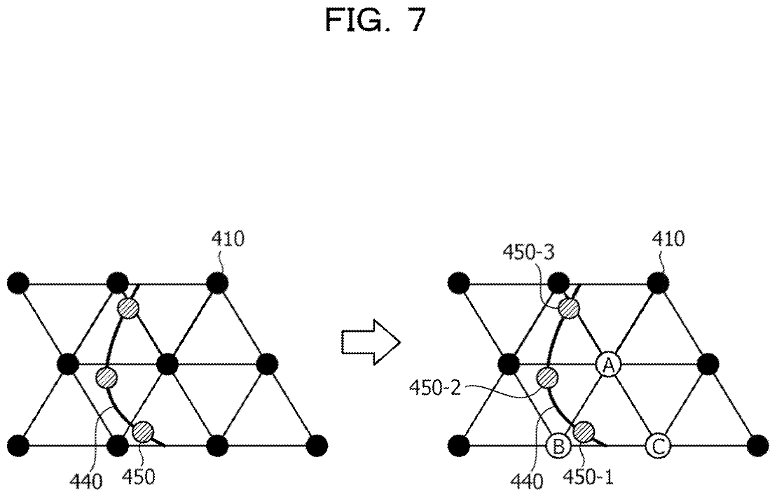

Next, generation of attitude information on an operation path by the generation unit 43 will be described. FIG. 7 is a diagram illustrating an example of the generation of the attitude information on the operation path. As illustrated on a left side of FIG. 7, the generation unit 43 sets points 450 at regular intervals, for example, 5 cm, on the operation path 440 specified by the specification unit 42.

Then, the generation unit 43 generates the attitude information 32 of the robot arm 100 when the tip of the robot arm 100 is positioned at the points 450 from the attitude information 32 of the robot arm 100 when the tip of the robot arm 100 is positioned at each of the imaginary points 410, which is acquired in advance. For more specific description, each of the points 450 is designated as points 450-1 to 450-3 as illustrated in a right side of FIG. 7. The generation unit 43 generates the attitude information 32 corresponding to the point 450-1 by interpolating, by a method such as linear interpolation, each of pieces of the attitude information 32 corresponding to the imaginary points 410 which are apexes of a triangular pyramid including the point 450-1 and are indicated by A to C on the right side of FIG. 7. Similarly, each of pieces of the attitude information 32 corresponding to the points 450-2 and 450-3 is also generated by interpolating the attitude information 32 corresponding to the imaginary points 410 which are apexes of a triangular pyramid including each point. Note that the interpolation method is not limited to the linear interpolation, and may be any other method. Furthermore, the part of the robot arm 100 that the generation unit 43 uses as a reference when generating the attitude information 32 may be a part other than the tip.

[Flow of Processing]

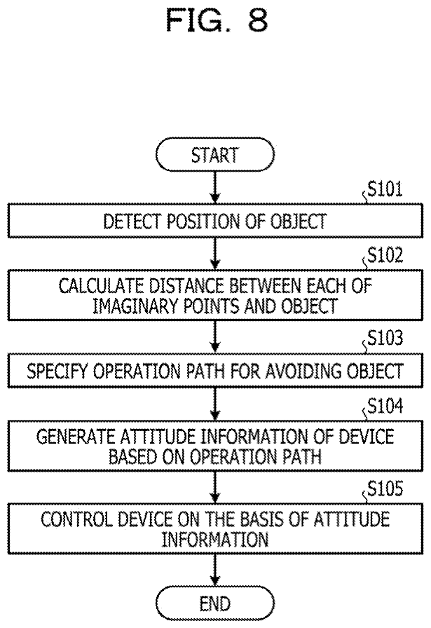

Next, a flow of operation control processing of a device such as the robot arm 100, which is executed by the operation control apparatus 10, will be described. FIG. 8 is a flowchart illustrating the flow of the operation control processing. The operation control processing illustrated in FIG. 8 is mainly executed by the operation control apparatus 10, and is executed in real time while the device is operating so that the device operates while avoiding an object. Thus, images of an operating environment of the operating device are captured by the camera device 200 at all times, and the captured images are transmitted to the operation control apparatus 10.

First, as illustrated in FIG. 8, the operation control apparatus 10 detects a position of the object included in the operating environment of the device (Step S101). Note that, until the object is detected in the operating environment of the device, the device is controlled on the basis of the attitude information 32 of the normal operation in a case where the object is not detected. Furthermore, the detection of the position of the object is, for example, performed by using the object detector 50 to specify a region of the object in a captured image in which the operating environment of the operating device is captured. The captured image is the latest captured image transmitted from the camera device 200, for example, a captured image at a current time. Furthermore, in a case where there is a plurality of captured images captured from a plurality of directions such as a side of and above the device, the operation control apparatus 10 specifies the region of the object in each image, and detects the position of the object.

Next, on the basis of the position information 31 of imaginary points preset in a space within an operation range of the device and the position of the object detected in Step S101, the operation control apparatus 10 calculates a distance between each of the imaginary points and the object (Step S102).

Next, the operation control apparatus 10 uses the position information 31 of imaginary points with the distance calculated in Step S102 of equal to or lower than a predetermined threshold to determine a predetermined region including the object as a region where path search is not possible, and specifies an operation path of the device to a target position for avoiding the region (Step S103).

Next, the operation control apparatus 10 sets points at regular intervals on the operation path specified in Step S103, and generates attitude information when a specific part of the device is positioned at each point from attitude information when the specific part of the device is positioned at the imaginary points (Step S104). The attitude information corresponding to each point is generated, for example, by interpolating attitude information corresponding to imaginary points forming a figure including each point on the operation path.

Next, the operation control apparatus 10 controls the device on the basis of the attitude information corresponding to each point on the operation path, which is generated in Step S104 (Step S105). With this configuration, the device may be operated while avoiding the object detected in the operating environment of the device. Note that, although the operation control processing illustrated in FIG. 8 ends after the execution of Step S105, the operation control apparatus 10 may further detect that the object has disappeared from the operating environment of the device, and return the operation of the device to the normal operation on the basis of the attitude information of the normal operation in a case where the object is not detected.

[Effects]

As described above, the operation control apparatus 10 detects a position of the object 150 included in an operating environment of a device such as the robot arm 100, specifies the operation path 440 of the device on the basis of an operation position of the device and the position of the object 150, generates first operation information on the basis of the operation path 440 and reference information that associates the position information 31 of a plurality of points included in the operating environment with operation information that represents an operating state of the device when the plurality of points are the operation positions, and controls the device on the basis of the first operation information.

In this way, on the basis of the position of the object 150 detected in the operating environment of the device such as the robot arm 100 and the operation position of the device, the operation control apparatus 10 specifies the operation path 440 of the device. Then, on the basis of the specified operation path 440, the position information 31 of the imaginary points 410 preset in a space within the operation range 400, and the attitude information 32 which is the operation information of the device when the imaginary points 410 are the operation positions, the attitude information 32 for avoiding the object 150 is generated to control the device. With this configuration, the operation control apparatus 10 may generate a track of the robot arm 100 for avoiding the object 150 that may be the obstacle 420.

Furthermore, the processing of specifying the operation path 440, which is executed by the operation control apparatus 10, includes processing of calculating a distance between each of the plurality of points and the object 150 on the basis of the position information 31 of the plurality of points and the position of the object 150, and specifying the operation path 440 on the basis of the position information 31 of points with the distance of equal to or lower than a threshold and the operation position of the device.

With this configuration, the operation control apparatus 10 may generate a track of the robot arm 100 for more efficiently and accurately avoiding the object 150 that may be the obstacle 420.

Furthermore, the processing of generating the first operation information, which is executed by the operation control apparatus 10, includes processing of setting points at regular intervals on the operation path 440, and calculating, on the basis of the reference information, the first operation information that represents the operating state of the device when the points at the regular intervals are the operation positions.

With this configuration, the operation control apparatus 10 may generate a track of the robot arm 100 for more accurately avoiding the object 150 that may be the obstacle 420.

Furthermore, the plurality of points is set in the space within the operation range 400 of the device.

With this configuration, the operation control apparatus 10 may generate a track of the robot arm 100 for more accurately avoiding the object 150 that may be the obstacle 420.

Furthermore, each of the plurality of points has a positional relationship corresponding to each of apexes of a triangular pyramid in a case where a plurality of triangular pyramids is connected.

With this configuration, the operation control apparatus 10 may generate a track of the robot arm 100 for more accurately avoiding the object 150 that may be the obstacle 420.

Furthermore, the operation control apparatus 10 further acquires the first operation information when a specific part of the device is positioned at a first point of the plurality of points on the basis of the operation position of the device and the position information 31 of the plurality of points, and generates the reference information on the basis of position information of the first point and the first operation information.

With this configuration, the operation control apparatus 10 may generate a track of the robot arm 100 for more accurately avoiding the object 150 that may be the obstacle 420.

Furthermore, the processing of detecting the position of the object 150, which is executed by the operation control apparatus 10, includes processing of specifying a region of the object 150 in an image obtained by capturing the operating environment from at least one direction.

With this configuration, the operation control apparatus 10 may more accurately detect the object 150 that may be the obstacle 420 and generate a track of the robot arm 100 for avoiding the object 150.

Furthermore, the processing of detecting the position of the object 150, which is executed by the operation control apparatus 10, includes processing of detecting that the object 150 has disappeared from the operating environment, and, in a case where it is detected that the object 150 has disappeared from the operating environment, the operation control apparatus 10 further controls the device on the basis of second operation information preset to represent a normal operating state of the device.

With this configuration, the operation control apparatus 10 may more efficiently operate the robot arm 100.

[System]

Pieces of information including a processing procedure, a control procedure, a specific name, various types of data, and parameters described above or illustrated in the drawings may be optionally changed unless otherwise specified. Furthermore, the specific examples, distributions, numerical values, and the like described in the embodiments are merely examples, and may be optionally changed.

Furthermore, each component of each device illustrated in the drawings is functionally conceptual and does not necessarily have to be physically configured as illustrated in the drawings. For example, specific forms of distribution and integration of each device are not limited to those illustrated in the drawings. For example, all or a part of the devices may be configured by being functionally or physically distributed or integrated in optional units according to various types of loads, usage situations, or the like. Moreover, all or an optional part of each processing function performed in each device may be implemented by a central processing unit (CPU) and a program analyzed and executed by the CPU, or may be implemented as hardware by wired logic.

[Hardware]

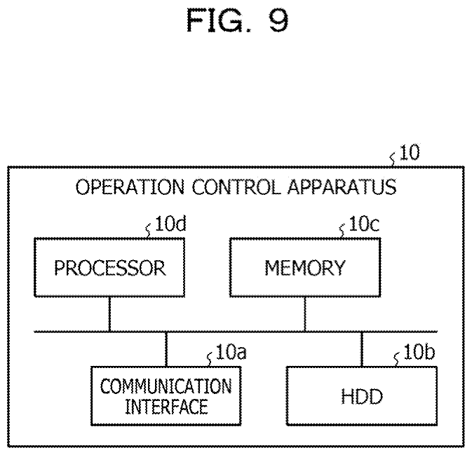

FIG. 9 is a diagram for explaining an exemplary hardware configuration. As illustrated in FIG. 9, the operation control apparatus 10 includes a communication interface 10a, a hard disk drive (HDD) 10b, a memory 10c, and a processor 10d. Furthermore, the units illustrated in FIG. 9 are mutually connected by a bus or the like.

The communication interface 10a is a network interface card or the like and communicates with another server. The HDD 10b stores a program for operating the functions illustrated in FIG. 3, and a DB.

The processor 10d is a hardware circuit that reads a program that executes processing similar to the processing of each processing unit illustrated in FIG. 3 from the HDD 10b or the like, and develops the read program in the memory 10c, to operate a process that executes each function described with reference to FIG. 3 or the like. For example, this process executes a function similar to the function of each processing unit included in the operation control apparatus 10. For example, the processor 10d reads a program having functions similar to the functions of the detection unit 41, the specification unit 42, the generation unit 43, the device control unit 44, and the like from the HDD 10b or the like. Then, the processor 10d executes a process that executes processing similar to the processing of the detection unit 41, the specification unit 42, the generation unit 43, the device control unit 44, and the like.

In this way, the operation control apparatus 10 operates as an information processing apparatus that executes the operation control processing by reading and executing a program that executes processing similar to the processing of each processing unit illustrated in FIG. 3. Furthermore, the operation control apparatus 10 may also implement functions similar to the functions of the embodiments described above by reading a program from a recording medium by a medium reading device and executing the read program. Note that the program mentioned in other embodiments is not limited to being executed by the operation control apparatus 10. For example, the present embodiment may be similarly applied also to a case where another computer or server executes the program, or a case where these cooperatively execute the program.

Furthermore, the program that executes processing similar to the processing of each processing unit illustrated in FIG. 3 may be distributed via a network such as the Internet. Furthermore, the program may be recorded in a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an operation control program for causing a computer to execute processing comprising:
detecting a position of an object included in an operating environment of a device;
specifying an operation path of the device on the basis of an operation position of the device and the position of the object;
generating first operation information on the basis of the operation path and reference information that associates position information of a plurality of points included in the operating environment with operation information that represents an operating state of the device when the plurality of points are the operation positions; and
controlling the device on the basis of the first operation information.

2. The non-transitory computer-readable recording medium storing the operation control program according to claim 1, wherein
the processing of specifying the operation path includes processing of
calculating a distance between each of the plurality of points and the object on the basis of the position information of the plurality of points and the position of the object, and
specifying the operation path on the basis of the position information of points with the distance of equal to or lower than a threshold and the operation position of the device.

3. The non-transitory computer-readable recording medium storing the operation control program according to claim 1, wherein
the processing of generating the first operation information includes processing of
setting points at regular intervals on the operation path, and
calculating, on the basis of the reference information, the first operation information that represents the operating state of the device when the points at the regular intervals are the operation positions.

4. The non-transitory computer-readable recording medium storing the operation control program according to claim 1, wherein the plurality of points is set in a space within an operation range of the device.

5. The non-transitory computer-readable recording medium storing the operation control program according to claim 1, wherein each of the plurality of points has a positional relationship that corresponds to each of apexes of a triangular pyramid in a case where a plurality of triangular pyramids is connected.

6. The non-transitory computer-readable recording medium storing the operation control program according to claim 1, for causing the computer to further execute processing of acquiring the first operation information when a specific part of the device is positioned at a first point of the plurality of points on the basis of the operation position of the device and the position information of the plurality of points, and generating the reference information on the basis of position information of the first point and the first operation information.

7. The non-transitory computer-readable recording medium storing the operation control program according to claim 1, wherein the processing of detecting the position of the object includes processing of specifying a region of the object in an image obtained by capturing the operating environment from at least one direction.

8. The non-transitory computer-readable recording medium storing the operation control program according to claim 1, wherein
the processing of detecting the position of the object includes processing of detecting that the object has disappeared from the operating environment, and
in a case where it is detected that the object has disappeared from the operating environment, the operation control program further causes the computer to execute processing of controlling the device on the basis of second operation information preset to represent a normal operating state of the device.

9. An operation control method comprising:
detecting a position of an object included in an operating environment of a device;
specifying an operation path of the device on the basis of an operation position of the device and the position of the object;
generating first operation information on the basis of the operation path and reference information that associates position information of a plurality of points included in the operating environment with operation information that represents an operating state of the device when the plurality of points are the operation positions; and
controlling the device on the basis of the first operation information.

10. The operation control method according to claim 9, wherein
the processing of specifying the operation path includes processing of
calculating a distance between each of the plurality of points and the object on the basis of the position information of the plurality of points and the position of the object, and
specifying the operation path on the basis of the position information of points with the distance of equal to or lower than a threshold and the operation position of the device.

11. The operation control method according to claim 9, wherein
the processing of generating the first operation information includes processing of
setting points at regular intervals on the operation path, and
calculating, on the basis of the reference information, the first operation information that represents the operating state of the device when the points at the regular intervals are the operation positions.

12. The operation control method according to claim 9, wherein the plurality of points is set in a space within an operation range of the device.

13. The operation control method according to claim 9, wherein each of the plurality of points has a positional relationship that corresponds to each of apexes of a triangular pyramid in a case where a plurality of triangular pyramids is connected.

14. The operation control method according to claim 9, for causing the computer to further execute processing of acquiring the first operation information when a specific part of the device is positioned at a first point of the plurality of points on the basis of the operation position of the device and the position information of the plurality of points, and generating the reference information on the basis of position information of the first point and the first operation information.

15. The operation control method according to claim 9, wherein the processing of detecting the position of the object includes processing of specifying a region of the object in an image obtained by capturing the operating environment from at least one direction.

16. The operation control method according to claim 9, wherein
the processing of detecting the position of the object includes processing of detecting that the object has disappeared from the operating environment, and
in a case where it is detected that the object has disappeared from the operating environment, the operation control program further causes the computer to execute processing of controlling the device on the basis of second operation information preset to represent a normal operating state of the device.

17. An information processing apparatus comprising:
a memory; and
a processor coupled to the memory and configured to:
detect a position of an object included in an operating environment of a device;
specify an operation path of the device on the basis of an operation position of the device and the position of the object;
generate first operation information on the basis of the operation path and reference information that associates position information of a plurality of points included in the operating environment with operation information that represents an operating state of the device when the plurality of points are the operation positions; and
control the device on the basis of the first operation information.

18. The information processing apparatus according to claim 17, wherein the processor
calculates a distance between each of the plurality of points and the object on the basis of the position information of the plurality of points and the position of the object, and
specifies the operation path on the basis of the position information of points with the distance of equal to or lower than a threshold and the operation position of the device.

19. The information processing apparatus according to claim 17, wherein the processor
sets points at regular intervals on the operation path, and
calculates, on the basis of the reference information, the first operation information that represents the operating state of the device when the points at the regular intervals are the operation positions.

20. The information processing apparatus according to claim 17, wherein the plurality of points is set in a space within an operation range of the device.
